(19) United States
(12) Patent Application Publication
(10) Pub. No.: US 2020/0255557 A1
(43) Pub. Date: Aug. 13, 2020

(54) LITHIUM POLY(ACRYLIC ACID) BINDERS FOR ANODES OF FAST CHARGING LITHIUM ION BATTERIES

(71) Applicant: Storedot Ltd., Herzeliya (IL)

(72) Inventors: Eran SELLA, Tel-Aviv (IL); Maxim KAGAN, Ness Ziona (IL); Ekaterina GOTLIB VAINSHTEIN, Petah Tikva (IL)

(73) Assignee: Storedot Ltd., Herzeliya (IL)

(21) Appl. No.: 16/711,484

(22) Filed: Dec. 12, 2019

Related U.S. Application Data
(60) Provisional application No. 62/802,357, filed on Feb. 7, 2019.

(51) Int. Cl. C08F 20/06; H01M 4/38; H01M 4/62; H01M 10/0525

(52) U.S. Cl. CPC C08F 20/06; H01M 4/386; H01M 10/0525; H01M 4/622; H01M 4/387

(57) ABSTRACT

Li-PAA (lithium poly(acrylic acid)) powders, electrode binders and methods of preparation thereof are provided. The Li-PAA powders have a low PDI (polydispersity index), e.g., smaller than 4 or 5, possibly a high M_{w}, and are configured to have a lithium content of above 7%, a pH between 8.5 and 9.5, or between 8.7 and 9.1 when dissolved 15% w/w in water and/or possibly a white color. Preparation methods comprise adding a PAA solution into a LiOH solution and stirring a resulting Li-PAA solution, and precipitating Li-PAA from the resulting Li-PAA solution, sieving or filtering and then drying the precipitated Li-PAA to yield the Li-PAA powder, which may be used as binder for forming electrodes. Advantageously, resulting electrodes are uniform and mechanically stable when used with metalloid anode material particles which exhibit high expansion and contraction when used in fast charging lithium ion batteries.

### CROSS-REFERENCE TO RELATED APPLICATION

This application claims the benefit of U.S. Provisional Patent Application No. 62/802,357, filed on Feb. 7, 2019, which is incorporated herein by reference in its entirety.

### BACKGROUND OF THE INVENTION

### 1. Technical Field

The present invention relates to the field of lithium ion batteries, and more particularly, to binders for electrodes thereof.

### 2. Discussion of Related Art

Fast charging lithium ion batteries is a central goal of the energy storage industry, presenting challenges concerning materials used to form the elements of the battery to provide long cycling lifetime and high performance.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a Li-PAA (lithium poly(acrylic acid)) powder having: a PDI (polydispersity index)<5, a lithium content above 7%, and a pH between 8.5 and 9.5 when dissolved 15% w/w in water.

One aspect of the present invention provides a method of preparing a Li-PAA powder, comprising: adding a PAA solution into a LiOH solution and stirring a resulting Li-PAA solution, wherein the resulting Li-PAA has a PDI<5, and precipitating Li-PAA from the resulting Li-PAA solution, sieving or filtering and then drying the precipitated Li-PAA to yield the Li-PAA powder, wherein the Li-PAA powder has a lithium content above 7%, and a pH between 8.5 and 9.5 when dissolved 15% w/w in water.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high-level schematic flowchart of a method of preparing a Li-PAA powder, according to some embodiments of the invention.

FIGS. 2A-2D illustrates inferior anodes prepared using Li-PAA binders which deviated from disclosed Li-PAA binders and preparation methods.

FIG. 3A is an image of the resulting electrode and FIG. 3B is a SEM (scanning electron microscopy) image showing its consistency and stable mechanical structure, according to some embodiments of the invention.

FIG. 4 provides experimental results that illustrate the dependence of anode adhesion on the PDI value, according to some embodiments of the invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanism for preparing electrode binders and thereby provide improvements to the technological field of lithium ion batteries.

Li-PAA (lithium poly(acrylic acid)) powders, electrode binders and methods of preparation thereof are provided. The Li-PAA powders have a low PDI (polydispersity index—PDI=M_{w}/Mₙ, also termed dispersity D, being the ratio between the weight-average molar mass M_{w} and the number-average molar mass Mₙ), e.g., smaller than 4 or 5, possibly a high M_{w}, e.g., between 200,000 and 500,000, and are configured to have a lithium content of above 7%, a pH between 8.5 and 9.5, or between 8.7 and 9.1 when dissolved 15% w/w in water and/or possibly a white color. Preparation methods comprise adding a PAA solution into a LiOH solution and stirring a resulting Li-PAA solution, and precipitating Li-PAA from the resulting Li-PAA solution, sieving or filtering and then drying the precipitated Li-PAA to yield the Li-PAA powder, which may be used as binder for forming electrodes. Advantageously, resulting electrodes are uniform and mechanically stable when used with metalloid anode material particles which exhibit high expansion and contraction when used in fast charging lithium ion batteries.

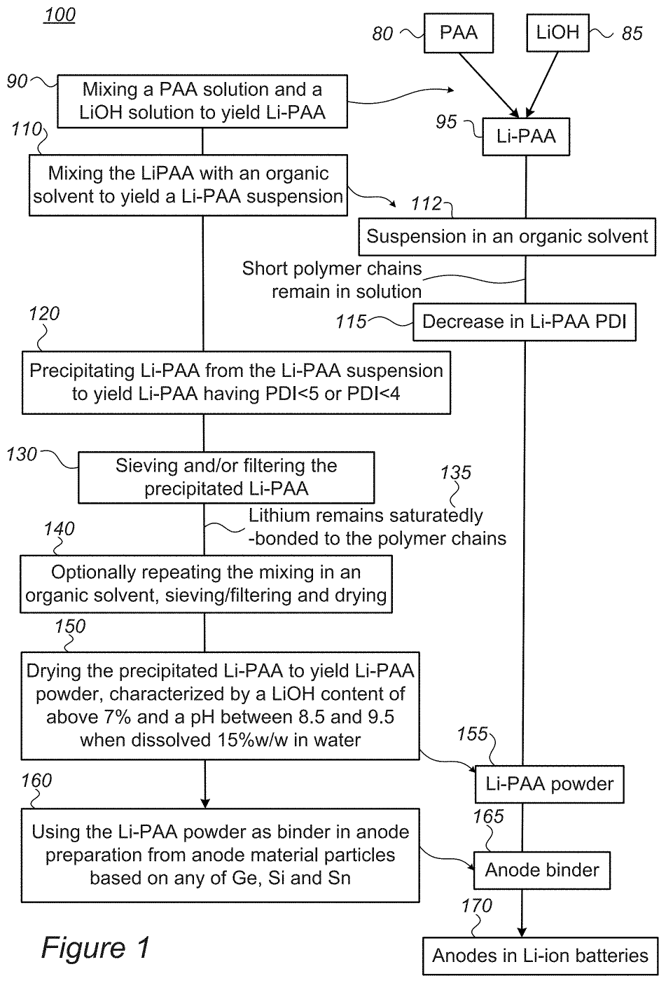

FIG. 1 is a high-level schematic flowchart of a method 100 of preparing a Li-PAA powder 155, according to some embodiments of the invention. Method 100 comprises mixing a PAA solution 80 and a LiOH solution 85 to yield Li-PAA 95 (stage 90), fully neutralizing PAA acidity by LiOH to yield high pH, e.g., by adding PAA solution 80 into LiOH solution 85 and stirring a resulting Li-PAA solution. Method 100 further comprises mixing Li-PAA 95 (as solution or after drying from the Li-PAA solution) with an organic solvent (e.g., methanol) to yield a Li-PAA suspension in organic solvent 112 (stage 110) and precipitating Li-PAA from Li-PAA suspension 112 (stage 120) to decrease the PDI of the Li-PAA to under 5 or under 4 (115), leaving short polymer chains in the organic solvent. Method 100 may further comprise sieving or filtering the precipitated Li-PAA (stage 130), while maintaining the polymer chains saturated with lithium (135), and drying the precipitated Li-PAA to yield Li-PAA powder 155 which is characterized by a LiOH content of above 7% (e.g., between 7% and 8% or above 8% up to the saturation value of ca. 8.67%) and a pH between 8.5 and 9.5 (or between 8.7 and 9.1) when dissolved 15% w/w in water (stage 150). In certain embodiments, Li-PAA powder 155 may be characterized by M_{w} between 200,000 and 500,000 (e.g., possibly in a range of about 220,000 to about 260,000, about 230,000 to about 250,000 or about 240,000, with values modified by the term “about” understood to encompass ±10% of the value). In certain embodiments, mixing in an organic solvent 110, sieving/filtering 130 and drying 150 may be repeated (stage 140) to further reduce the PDI and/or to further purify the Li-PAA. In various embodiments, method 100 may further comprise a least one cleaning stage of any of the Li-PAA powder or slurry phases. Method 100 may further comprise using Li-PAA powder 155 as binder 165 in anode preparation from anode material particles based on any of Ge, Si and Sn (stage 160), for preparing anodes for Li-ion batteries 170. In various embodiments, electrodes made with Li-PAA binder 165 may comprise anodes 170 with anode material based on at least one of Si, Ge and Sn, having 5-40 wt % of Li-PAA binder 165.

Without being bound by theory, the inventors have found out that modifications to the distribution of molecular weights of the Li-PAA, in particular reduction of the PDI to below 5, or below 4 (115), increases the adhesion of the anodes, provides workable anodes, and maintains lithium binding to the PAA saturated (135). Disclosed changes and production steps of the Li-PAA powder also improve its efficiency as an electrode binder and enables the use of electrodes formed therewith for fast charging lithium ion batteries. Disclosed Li-PAA powder 155 is advantageous with respect to prior art Li-PAA in fast charging electrodes with respect to their mechanical stability, especially when the active material expands and contracts greatly during operation, e.g., as is the case with metalloid-based active material such as Si, Ge and/or Sn, and/or in fast charging applications. Specifically, prior art Li-PAA typically has a wider range of molecular weights, characterized by PDI values above 5, e.g., 7, 8 or 9, a lower lithium content, typically below 7% and a lower pH, typically below 7.5.

In certain embodiments, Na-PAA and/or K-PAA powders may also be produced, having corresponding PDI<5 or PDI<4, corresponding saturated Na/K of ca. 24%/35% respectively, or at least 20%/28%, respectively.

In certain embodiments, PAA 80 may be used with PDI<4 or PDI<5 before mixing it with LiOH 85.

In certain embodiments, the radical polymerization reaction of PAA and/or of Li-PAA may be controlled by any of a range of radical polymerization controlling agents, e.g., RAFT (Reversible addition-fragmentation chain-transfer polymerization), BHT (butylated hydroxytoluene), TEMPO ((2,2,6,6-Tetramethylpiperidin-1-yl)oxyl), or other chain transfer agents, being compounds comprising a weak bond (e.g., a —C(═S)—S— moiety, a dithioester functional group) which facilitate a chain transfer reaction, usually within a polymerization process/reaction. However, the inventors note that as control of PAA radical polymerization reaction can be challenging, disclosed method 100 including mixing the Li-PAA with an organic solvent to yield a Li-PAA suspension (stage 110) may be used as disclosed to reduce the PDI of Li-PAA prepared from PAA having PDI>5, PDI>6 or PDI>7-to Li-PAA having PDI<5 or PDI<4.

In the following examples it is shown that Li-PAA with larger PDIs, with lower lithium content and/or with lower pH provide inferior and inappropriate anode binders, while Li-PAA with PDI<5 or PDI<4, lithium content above 7% and a pH between 8.5 and 9.5 provide appropriate anode binders for metalloid-based anodes of fast charging Li-ion cells and/or batteries.

In the examples, the materials used are: (i) PAA solution 80 comprises 25 wt % poly(acrylic acid) in water, provided by Alfa Aesar PN: 44669 and having average molecular weight (M_{w}) of 240,000. In certain embodiments, higher concentrations of PAA in the PAA solution may be used. It is noted that different molecular weight distributions may have the same average M_{w}. In certain embodiments, the PAA is selected to have long chains, e.g., as much as possible around W=240,000. (ii) LiOH solution 85 comprises lithium hydroxide monohydrate LiOH*H₂O 98% powder, provided by ACROS P/N 41332.

In the non-limiting example presented below, 136 gr LiOH*H₂O were dissolved in 1105 ml of H₂O to form LiOH solution 85 and 909 gr of PAA 25% were added (stage 90) by slowly dripping (accompanied by some heat release) while vigorously stirring resulting in Li-PAA solution 95, which was them further stirred for 24 h.

In precipitation stage 120, resulting Li-PAA solution 95 was slowly dripped into 20 L MeOH as the first MeOH solution while stirring, to form a thick white slurry as suspension 112. At sieving stage 130, the thick white Li-PAA slurry was stirred for 5 min and filtered using a coarse sieve having a mesh size of several tens of micron, without application of vacuum or other force.

The sieved slurry was then mixed with 6.6 L MeOH as the second MeOH, stirred for 5 min and filtered (repeated mixing 140), resulting in 7-8% concentration of lithium and a pH of ca. 9 (typically between 8.5 and 9.5 or between 8.7-9.1) of the powder final product (Li-PAA powder 155), when mixed in 15% w solution in water.

Following a washing stage in which solvent residues like MeOH and water were removed, the washed slurry was dried (stage 150) in 105° C. for 24 hr and examined for LOD (loss on drying)<2%, in a non-limiting manner. The resulting yield was typically about 90% of the initial PAA quantity (ca. 200 gr with the above-stated quantities). Li-PAA powder 155 was stored under dry atmosphere, at room temperature and sealed under inert gas (Ar in N₂)—before using it for anode preparation (stage 160).

Different batches of PAA 80 were used to prepare Li-PAA powders 155 with lower PDI values. For example:

Received PAA 80 with PDI=5.0861 was prepared to yield Li-PAA powders 155 with PDI=3.1630 and PDI=3.1374

Received PAA 80 with PDI=8.7089 was prepared to yield Li-PAA powder 155 with PDI=4.7225.

Received PAA 80 with PDI=9.4052 was prepared to yield Li-PAA powder 155 with PDI=4.9330.

Received PAA 80 with PDI=7.6548 was prepared to yield Li-PAA powder 155 with PDI=4.8387.

Comparison to Li-PAA with Lower pH and Lower Lithium Content

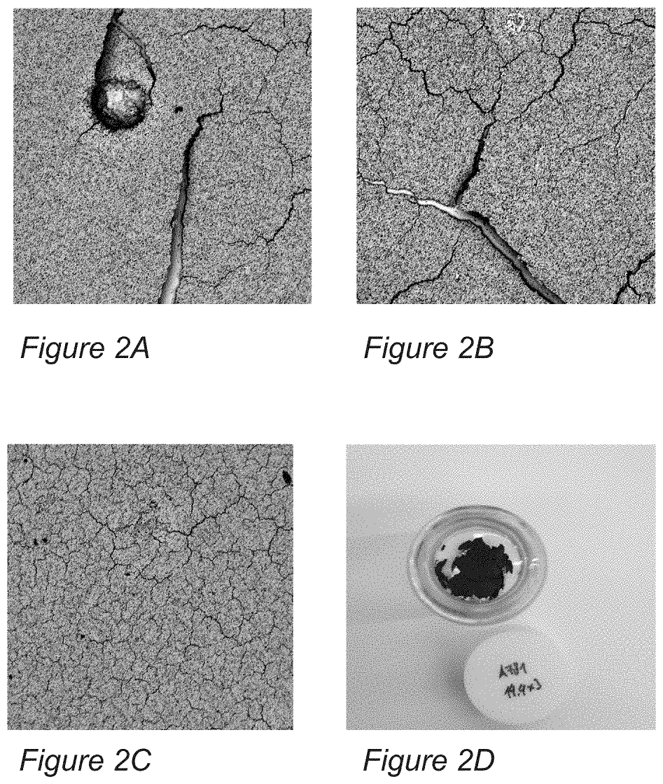

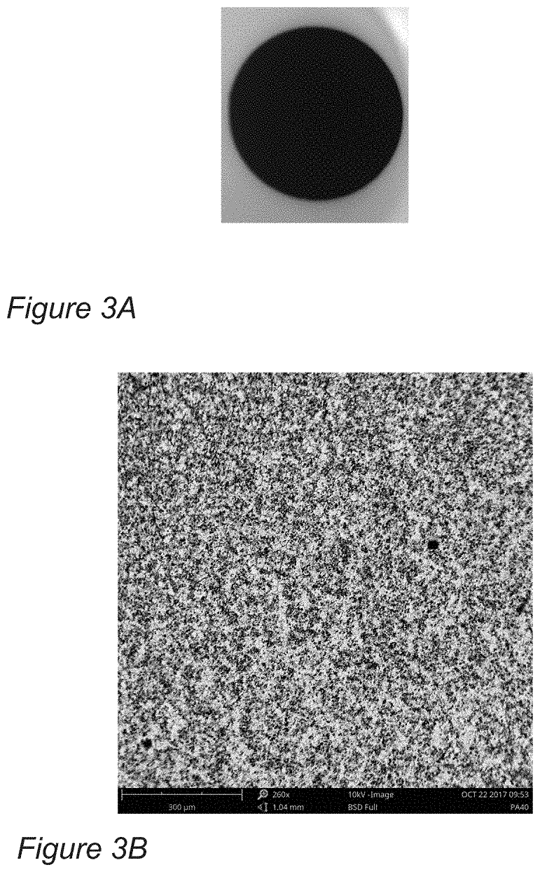

In the following, differences in Li content and pH are shown to be crucial to the formation of mechanically-stable anodes from the Li-PAA binder. Lower Li content and lower pH, achieved through a more intensive washing stage, resulted in inferior Li-PAA binders and mechanically instable anode prepared therefrom (FIGS. 2A-2D), with respect to anodes prepared as disclosed (FIGS. 3A and 3B).

Both Li-PAA powders 155 had similar PDIs, 3.847 and 3.743 respectively, but different lithium content of 7.7% w/w and pH of 7.5 (as well as a finer texture and a more pink hue) versus lithium content of 9.0% w/w and pH of 9 (which was more flaky and whiter). The former Li-PAA was produced with more intensive washing and finer sieving than the latter Li-PAA, which reduced the LiOH content of the resulting Li-PAA powder. Anode preparation 160 was carried out with germanium (Ge), graphite and conductive additive powders stirred and added to the binder solution and mixed for 5 min in vacuum at 2000 RPM. Following addition of deionized (DI) water while stirring (conductivity 0.055 uS/cm, added in two portions with stirring, 2 min at 2000 RPM after each addition, and stirring the slurry overnight), foil coating (on a CFLB9 Cu foil) and drying (at 80° C. overnight).

FIGS. 2A and 2B illustrate cracks in anodes prepared from the first Li-PAA powder 155 with low lithium content and low pH, FIG. 2C illustrates less cracks in anodes made of the first Li-PAA powder 155 after correction to pH=9, illustrating that the correction did not suffice to yield operative anodes, and FIG. 2D illustrates crumbling of the anode made of the first Li-PAA powder 155 under vacuum.

FIGS. 3A and 3B illustrate anodes prepared with the second, disclosed Li-PAA powder 155 which stay intact under vacuum, as illustrated in FIG. 3A, and have a stable mechanical structure, as illustrated in the SEM image of FIG. 3B.

Advantageously, disclosed methods provide ways of preparing Li-PAA electrode binders which are particularly well suited for metalloid-based anodes.

In the example provided above, 15 wt % Li-PAA was used for the Ge-based system, resulting in anodes having 1.3-1.9 mg/cm² anode load. Similar experiments and correlated results were conducted with Si-based systems (comparing purified and unpurified Li-PAA), increasing pH from unpurified Li-PAA having a pH=6 to purified Li-PAA having a pH between 8.5 and 9.5, as for Ge, using a range of 10-30 wt % Li-PAA, resulting in anodes having 1.5-2.5 mg/cm² anode load. Disclosed Li-PAA may be used as binder in anodes which are based on any of Si, Ge and Sn as active material.

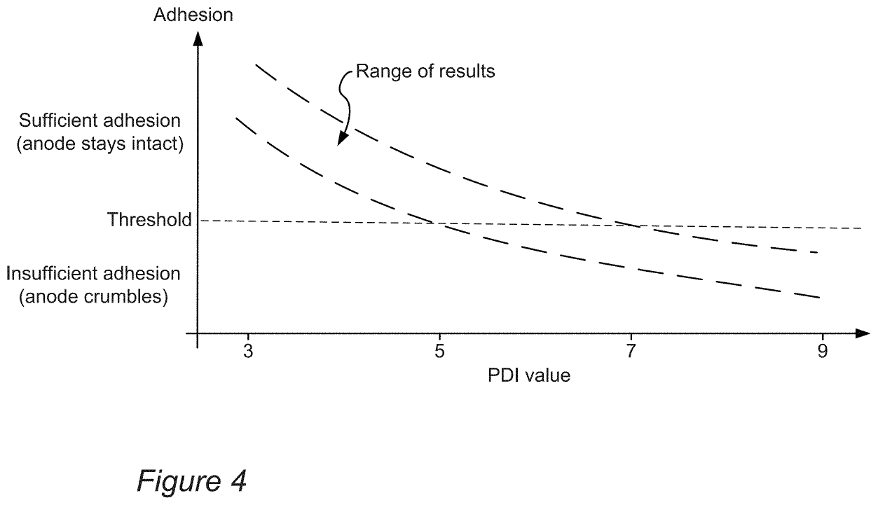

FIG. 4 provides experimental results that illustrate the dependence of anode adhesion on the PDI value, according to some embodiments of the invention. The adhesion was measured on the prepared electrodes using the tape method, in which a pressure sensitive tape is applied and removed over the electrode surface. Then, the tape and the electrode surface are inspected and rated according to the mechanical damage that is imparted onto them, and the electrode is classified as having sufficient adhesion (electrode remained intact) or as having insufficient adhesion (electrode crumbled or suffered other mechanical damage). FIG. 4 depicts a range of results, relating the measure for adhesion with the PDI value of the Li-PAA binder. Above PDI=5, mechanical damage to the electrode starts to occur, and above PDI=7 all electrodes suffer mechanical damage.

It is emphasized that there is a strong relation between the electrode adhesion and the overall cell performance, because insufficient adhesion results in anodes that lack mechanical stability and may crumble, leading to very short cycling lifetimes for the battery. Advantageously, disclosed Li-PAA binders 165 provide sufficient anode adhesion, enabling to produce batteries with long cycling lifetime (e.g., of hundreds or over a thousand cycles).

Disclosed Li-PAA binders 165 may be used to form electrodes of rechargeable Li-ion batteries. For example, disclosed Li-PAA binders 165 may be used to form metalloid-based anodes of fast charging Li-ion batteries. Disclosed embodiments may be implemented in lithium ion batteries to improve their cycle lifetime, charging/discharging rates, safety and/or capacity. The lithium ion batteries typically comprise anodes and cathodes with current collectors affixed thereto, packed with electrolyte and separator(s) in a battery pouch. Anodes are typically made of anode material particles, conductive additive(s) and binder(s), and may comprise any of the anode configurations taught, e.g., by U.S. Patent Publication No. 2017/0294687, incorporated herein by reference in its entirety. For example, anodes may be based on graphite, graphene or metalloid anode material such as Si, Ge, Sn and their combinations.

Cathodes may comprise materials based on layered, spinel and/or olivine frameworks, such as LCO formulations (based on LiCoO₂), NMC formulations (based on lithium nickel-manganese-cobalt), NCA formulations (based on lithium nickel cobalt aluminum oxides), LMO formulations (based on LiMn₂O₄), LMN formulations (based on lithium manganese-nickel oxides) LFP formulations (based on LiFePO₄), lithium rich cathodes, and/or combinations thereof. In certain embodiments, disclosed Li-PAA binders may be used to form cathodes.

Separator(s) may comprise various materials, e.g., polymers such as any of polyethylene (PE), polypropylene (PP), polyethylene terephthalate (PET), poly vinylidene fluoride (PVDF), polymer membranes such as a polyolefin, polypropylene, or polyethylene membranes. Multi-membranes made of these materials, micro-porous films thereof, woven or non-woven fabrics etc. may be used as separator(s), as well as possibly composite materials including, e.g., alumina, zirconia, titania, magnesia, silica and calcium carbonate along with various polymer components as listed above.

Electrolytes may be based on liquid electrolytes, typically linear and cyclic carbonates, such as ethylene carbonate, diethyl carbonate, propylene carbonate, VC (vinylene carbonate), FEC (fluoroethylene carbonate), EA (ethyl acetate), EMC (ethyl methyl carbonate), DMC (dimethyl carbonate) and combinations thereof and/or solid electrolytes such as polymeric electrolytes such as polyethylene oxide, fluorine-containing polymers and copolymers (e.g., polytetrafluoroethylene), and combinations thereof. Electrolytes may comprise lithium electrolyte salt(s) such as LiPF₆, LiBF₄, lithium bis(oxalato)borate, LiN(CF₃SO₂)₂, LiN(C₂F₅SO₂)₂, LiAsF₆, LiC(CF₃SO₂)₃, LiClO₄, LiTFSI, LiB(C₂O₄)₂, LiBF₂(C₂O₄)), tris(trimethylsilyl)phosphite (TMSP), and combinations thereof. Ionic liquid(s) may be added to the electrolyte as taught by WIPO Publication No. WO2018/109774, incorporated herein by reference in its entirety. For example, electrolytes may comprise a large proportion, e.g., 10%, 20%, 30% or more of VC and/or FEC as prominent cyclic carbonate compound, as disclosed e.g., in U.S. Pat. No. 10,199,677, incorporated herein by reference in its entirety.

Disclosed lithium ion batteries may be configured, e.g., by selection of materials, to enable operation at high charging and/or discharging rates (C-rate), ranging from 3-10 C-rate, 10-100 C-rate or even above 100C, e.g., 5C, 10C, 15C, 30C or more. It is noted that the term C-rate is a measure of charging and/or discharging of cell/battery capacity, e.g., with 1C denoting charging and/or discharging the cell in an hour, and XC (e.g., 5C, 10C, 50C etc.) denoting charging and/or discharging the cell in 1/X of an hour—with respect to a given capacity of the cell.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A Li-PAA (lithium poly(acrylic acid)) powder having:
a PDI (polydispersity index)<5,
a lithium content above 7%, and
a pH between 8.5 and 9.5 when dissolved 15% w/w in water.

2. The Li-PAA powder of claim 1, having the PDI<4.

3. The Li-PAA powder of claim 1, having the pH between 8.7 and 9.1.

4. The Li-PAA powder of claim 1, having M_{w} (weight-average molar mass) between 200,000 and 500,000.

5. An electrode prepared using the Li-PAA powder of claim 1 as binder.

6. The electrode of claim 5, configured as an anode with anode material based on at least one of Si, Ge and Sn, having 5-40 wt % of the Li-PAA binder.

7. A lithium-ion battery comprising, as at least one anode thereof, the electrode of claim 5 with anode material particles based on Ge, Si, Sn, or a combination thereof.

8. A method of preparing a Li-PAA powder, comprising:
adding a PAA solution into a LiOH solution and stirring a resulting Li-PAA solution, wherein the resulting Li-PAA has a PDI<5, and
precipitating Li-PAA from the resulting Li-PAA solution, sieving or filtering and then drying the precipitated Li-PAA to yield the Li-PAA powder,
wherein the Li-PAA powder has a lithium content above 7%, and a pH between 8.5 and 9.5 when dissolved 15% w/w in water.

9. The method of claim 8, wherein the PAA solution has a PDI<4.

10. The method of claim 8, wherein the resulting Li-PAA powder has M_{w} between 200,000 and 500,000.

11. The method of claim 8, wherein the sieving or filtering are configured to yield the Li-PAA powder having a pH between 8.7 and 9.1 when dissolved 15% w/w in water.

12. The method of claim 8, wherein the precipitated Li-PAA is sieved.

13. The method of claim 8, further comprising a least one cleaning stage of a slurry of the sieved or filtered precipitated Li-PAA before the drying.

14. The method of claim 8, further comprising suspending the Li-PAA solution in an organic solvent and wherein the precipitating is carried out from the suspension.

15. A method comprising forming an anode with the Li-PAA powder of claim 8 as binder, and anode material particles being based on Ge, Si, Sn, or a combination thereof.

16. A method for making a lithium poly(acrylic acid) powder, comprising:
adding a PAA solution into a LiOH solution and stirring a resulting Li-PAA solution, wherein the resulting Li-PAA is characterized by a PDI<5, suspending the Li-PAA solution in a first MeOH solution,
precipitating Li-PAA from the resulting Li-PAA suspension to yield a Li-PAA slurry,
sieving the Li-PAA slurry,
adding the sieved slurry to a second MeOH solution, and
drying the sieved slurry to yield Li-PAA powder,
wherein the Li-PAA powder is characterized by a lithium content of between 7-8% and a pH between 8.5 and 9.5 when dissolved 15% w/w in water.

17. The method of claim 16, wherein the PAA solution has a PDI<4.

18. The method of claim 16, wherein the resulting Li-PAA powder has M_{w} between 200,000 and 500,000.

19. A method comprising forming an anode with the Li-PAA powder of claim 16 as binder, and anode material particles based on Ge, Si, Sn, or a combination thereof.
